(19) United States
(12) Patent Application Publication
(10) Pub. No.: US 2013/0204563 A1
(43) Pub. Date: Aug. 8, 2013

(54) PRINTING INSPECTION APPARATUS, PRINTING INSPECTION SYSTEM, STATISTICAL METHOD FOR INSPECTION DATA, PROGRAM, AND SUBSTRATE MANUFACTURING METHOD

(71) Applicant: Sony Corporation, Tokyo (JP)

(72) Inventors: Shinji Hirai, Gifu (JP); Katsuya Ido, Aichi (JP)

(73) Assignee: Sony Corporation, Tokyo (JP)

(21) Appl. No.: 13/749,917

(22) Filed: Jan. 25, 2013

(30) Foreign Application Priority Data
Feb. 3, 2012 (JP) 2012-021482

(51) Int. Cl. G06F 17/18; G01B 21/22

(52) U.S. Cl. CPC G06F 17/18; G01B 21/22
USPC 702/82; 702/81; 702/84

(57) ABSTRACT

A printing inspection apparatus includes a measurement unit and a controller. The measurement unit is configured to measure solder that is printed on a substrate with a squeegee of a screen printing apparatus, the screen printing apparatus including a plurality of squeegees that slide on a screen in different slide directions to print solder on different substrates. The controller is configured to determine a slide direction of the squeegee that prints the solder based on measured data of the solder, the measured data being obtained by the measurement unit, and execute statistical processing of inspection data of the solder based on the measured data of the solder for each of the slide directions of the squeegees.

### BACKGROUND

The present disclosure relates to a technology of a printing inspection apparatus that inspects solder printed on a substrate by a screen printing apparatus, a statistical method for inspection data of solder, and the like.

From the past, a screen printing apparatus for printing cream solder on a substrate by screen printing has been widely known (see, for example, Japanese Patent Application Laid-open No. 2010-234627). In the screen printing apparatus, a squeegee is arranged above a screen, to which patterned holes corresponding to a print pattern are provided, and a substrate is arranged below the screen. Cream solder is supplied to the screen. The squeegee slides on the screen. When the squeegee slides on the screen, the cream solder is pushed by the squeegee and moved on the patterned holes provided to the screen. Thus, the cream solder is printed on the substrate arranged below the screen.

To efficiently print the cream solder on the substrate, the screen printing apparatus includes two squeegees that alternately execute printing, in some cases. Those two squeegees generally slide on the screen in opposite directions.

In recent years, a printing inspection apparatus that inspects a printed state of solder printed on a substrate by the screen printing apparatus is generally arranged downstream of the screen printing apparatus. The printing inspection apparatus analyzes an image obtained by imaging the solder printed on the substrate and measures a two-dimensional or three-dimensional shape of the solder. Then, the printing inspection apparatus determines whether there is a shortage of the solder or not to determine whether the printed state of the solder is good or not good, and then executes processing of discarding a substrate that is determined to be not good.

### SUMMARY

As described above, in the screen printing apparatus, two squeegees whose slide directions on the screen are different from each other may be provided. In this case, the solder printed on the substrate is solder printed with one of the two squeegees.

In related art, however, it is difficult to determine with which of the two squeegees the solder is printed. Therefore, in the case where a failure of solder printing occurs, there is a problem that a cause of the failure of the solder printing is difficult to identify.

In view of the circumstances as described above, there is a need for a technology of a printing inspection apparatus capable of easily identifying a cause of a failure of solder printing, and the like.

According to an embodiment of the present disclosure, there is provided a printing inspection apparatus including a measurement unit and a controller.

The measurement unit is configured to measure solder that is printed on a substrate with a squeegee of a screen printing apparatus, the screen printing apparatus including a plurality of squeegees that slide on a screen in different slide directions to print solder on different substrates.

The controller is configured to determine a slide direction of the squeegee that prints the solder based on measured data of the solder, the measured data being obtained by the measurement unit, and execute statistical processing of inspection data of the solder based on the measured data of the solder for each of the slide directions of the squeegees.

In the printing inspection apparatus, since the statistical processing of the inspection data of the solder is executed for each of the slide directions of the squeegees, an operator (or computer) can easily identify a cause of a printing failure of the solder. For example, in the case where an operation failure occurs in one of the plurality of squeegees, an abnormality appears in inspection data of the solder printed with the squeegee. Therefore, the operator (or computer) can easily identify the abnormality of the squeegee.

In the printing inspection apparatus, the controller may be configured to calculate the center of gravity of a volume and the center of gravity of an area of the solder based on the measured data of the solder, and determine the slide direction of the squeegee that prints the solder based on a position of the center of gravity of a volume and a position of the center of gravity of an area of the solder.

Accordingly, based on the measured data of the solder, the slide direction of the squeegee can be accurately determined.

In the printing inspection apparatus, the controller may be configured to calculate an inclination of height of the solder based on the measured data of the solder, and determine the slide direction of the squeegee that prints the solder based on the inclination of the height of the solder.

Accordingly, based on the measured data of the solder, the slide direction of the squeegee can be accurately determined.

In the printing inspection apparatus, the squeegee may be configured to print the solder on the substrate to obtain a plurality of soldered parts, the measurement unit may be configured to measure at least two of the soldered parts printed on the substrate, and the controller may be configured to determine the slide direction of the squeegee based on measured data of the at least two of the soldered parts, the measured data being obtained by the measurement unit.

Accordingly, based on the measured data of the solder, the slide direction of the squeegee can be accurately determined.

The printing inspection apparatus may further include a display configured to display the inspection data obtained for each of the slide directions of the squeegees.

In the printing inspection apparatus, the operator can identify a cause of a printing failure of the solder by visually recognizing the inspection data of the solder obtained for each of the slide directions of the squeegees, the inspection data being displayed on a monitor of the display.

The printing inspection apparatus may further include a communication unit configured to communicate with the screen printing apparatus.

In this case, the controller may be configured to output information indicating the inspection data obtained for each of the slide directions of the squeegees to the screen printing apparatus via the communication unit.

The screen printing apparatus can receive the inspection data obtained for each of the slide directions of the squeegees and display the inspection data on the monitor of the display of the screen printing apparatus, for example.

In the printing inspection apparatus, the controller may be configured to detect a printing failure of the solder due to the screen printing apparatus based on the inspection data, and identify, when the printing failure of the solder is detected, at least one candidate that is assumed to be a cause of the printing failure, based on the inspection data obtained for each of the slide directions of the squeegees.

The printing inspection apparatus may further include a display configured to display the at least one candidate that is assumed to be a cause of the printing failure, the at least one candidate being identified by the controller, on a monitor.

In this printing inspection apparatus, the operator can identify a cause of the printing failure of the solder more easily by visually recognizing at least one candidate of a cause the printing failure displayed on the monitor of the display.

In the case where the printing inspection apparatus further includes a communication unit configured to communicate with the screen printing apparatus, the controller may be configured to output information indicating the identified at least one candidate that is assumed to be a cause of the printing failure to the screen printing apparatus via the communication unit.

In the printing inspection apparatus, the controller may be configured to output information indicating the at least one candidate that is assumed to be a cause of the printing failure via the communication unit, to automatically eliminate the cause of the printing failure by the screen printing apparatus.

Accordingly, with the screen printing apparatus, a cause of the printing failure of the solder can be automatically eliminated.

According to another embodiment of the present disclosure, there is provided a printing inspection system including a screen printing apparatus and a printing inspection apparatus.

The screen printing apparatus includes a plurality of squeegees that slide on a screen in different slide directions to print solder on different substrates.

The printing inspection apparatus includes a measurement unit and a controller. The measurement unit is configured to measure the solder that is printed on the substrates with the plurality of squeegees of the screen printing apparatus. The controller is configured to determine a slide direction of one of the squeegees that prints the solder based on measured data of the solder, the measured data being obtained by the measurement unit, and execute statistical processing of inspection data of the solder based on the measured data of the solder for each of the slide directions of the squeegees.

According to another embodiment of the present disclosure, there is provided a statistical method for inspection data, including:

measuring solder that is printed on a substrate with a squeegee of a screen printing apparatus, the screen printing apparatus including a plurality of squeegees that slide on a screen in different slide directions to print solder on different substrates;

determining a slide direction of the squeegee that prints the solder based on measured data of the solder, the measured data being obtained by the measuring; and

executing statistical processing of inspection data of the solder based on the measured data of the solder for each of the slide directions of the squeegees.

According to another embodiment of the present disclosure, there is provided a program causing a printing inspection apparatus to execute:

measuring solder that is printed on a substrate with a squeegee of a screen printing apparatus, the screen printing apparatus including a plurality of squeegees that slide on a screen in different slide directions to print solder on different substrates;

determining a slide direction of the squeegee that prints the solder based on measured data of the solder, the measured data being obtained by the measuring; and

executing statistical processing of inspection data of the solder based on the measured data of the solder for each of the slide directions of the squeegees.

According to another embodiment of the present disclosure, there is provided a substrate manufacturing method, including:

measuring solder that is printed on a substrate with a squeegee of a screen printing apparatus, the screen printing apparatus including a plurality of squeegees that slide on a screen in different slide directions to print solder on different substrates;

determining a slide direction of the squeegee that prints the solder based on measured data of the solder, the measured data being obtained by the measuring;

executing statistical processing of inspection data of the solder based on the measured data of the solder for each of the slide directions of the squeegees;

identifying a cause of a printing failure of the solder due to the screen printing apparatus based on the inspection data obtained for each of the slide directions of the squeegees;

eliminating the identified cause of the printing failure due to the screen printing apparatus;

printing the solder on the substrate by the screen printing apparatus from which the cause of the printing failure is eliminated; and

mounting an electronic component onto the substrate on which the solder is printed.

As described above, according to the present disclosure, it is possible to provide a technology of a printing inspection apparatus capable of easily identifying a cause of a failure of solder printing, and the like.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a printing inspection system according to an embodiment of the present disclosure;

FIG. 2 is a front view of a screen printing apparatus;

FIG. 3 is a side view of the screen printing apparatus;

FIG. 4 is a top view of a screen of the screen printing apparatus;

FIGS. 5A and 5B are side views of the screen printing apparatus, each showing a state in which solder is being printed on a substrate by a squeegee;

FIG. 6 is a block diagram showing the configuration of the screen printing apparatus;

FIG. 7 is a diagram showing the configuration of a printing inspection apparatus;

FIG. 8 is a diagram for describing a determination method for a slide direction of the squeegee;

FIG. 9 is a diagram for comparison between inspection data of solder, which is obtained without consideration of the slide direction of the squeegee, and inspection data of solder, which is obtained in consideration of the slide direction of the squeegee;

FIG. 10 is a diagram for comparison between inspection data of solder, which is obtained without consideration of the slide direction of the squeegee, and inspection data of solder, which is obtained in consideration of the slide direction of the squeegee;

FIG. 11 is a diagram for comparison between inspection data of solder, which is obtained without consideration of the slide direction of the squeegee, and inspection data of solder, which is obtained in consideration of the slide direction of the squeegee;

FIG. 12 is a diagram for comparison between inspection data of solder, which is obtained without consideration of the slide direction of the squeegee, and inspection data of solder, which is obtained in consideration of the slide direction of the squeegee; and

FIG. 13 is a flowchart showing processing of a controller of the printing inspection apparatus.

### DETAILED DESCRIPTION OF EMBODIMENTS

Hereinafter, embodiments of the present disclosure will be described with reference to the drawings.

(Configuration of Printing Inspection System 300)

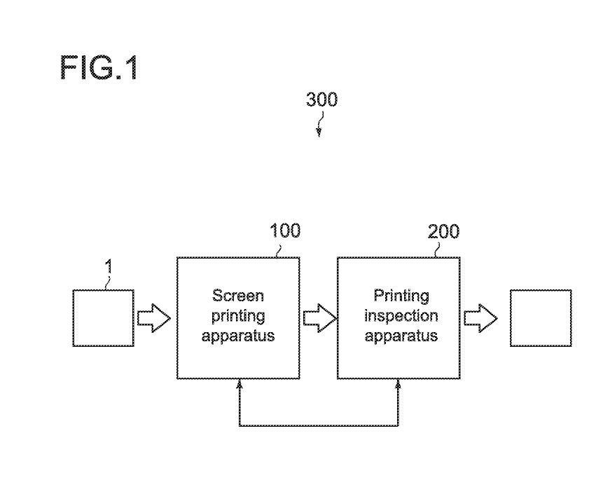

FIG. 1 is a diagram showing a printing inspection system 300 according to an embodiment of the present disclosure. As shown in FIG. 1, the printing inspection system 300 includes a screen printing apparatus 100 and a printing inspection apparatus 200 arranged downstream of the screen printing apparatus 100.

The screen printing apparatus 100 prints cream solder 2 (hereinafter, simply referred to as solder 2) on a substrate 1 transferred from a substrate feeding apparatus (not shown) arranged upstream of the screen printing apparatus 100. Then, the screen printing apparatus 100 transfers the substrate 1, on which the solder 2 is printed, to the printing inspection apparatus 200.

The printing inspection apparatus 200 inspects a printed state of the solder 2, which is printed on the substrate 1 by the screen printing apparatus 100. The screen printing apparatus 100 and the printing inspection apparatus 200 are connected to each other via a communication cable so as to be communicable with each other. The screen printing apparatus 100 and the printing inspection apparatus 200 may communicate with each other by radio waves.

The printing inspection apparatus 200 determines whether the printed state of the solder 2 is good or not good. The printing inspection apparatus 200 transfers the substrate 1 whose printed state of the solder 2 is determined to be “good” to a mounting apparatus (not shown) arranged downstream of the printing inspection apparatus 200. On the other hand, the printing inspection apparatus 200 discards the substrate 1 that is determined to be “not good”. The substrate 1 on which the solder 2 is printed and which is determined to be good is transferred from the printing inspection apparatus 200 to the mounting apparatus. The mounting apparatus mounts an electronic component onto the substrate 1.

(Configuration of Screen Printing Apparatus 100)

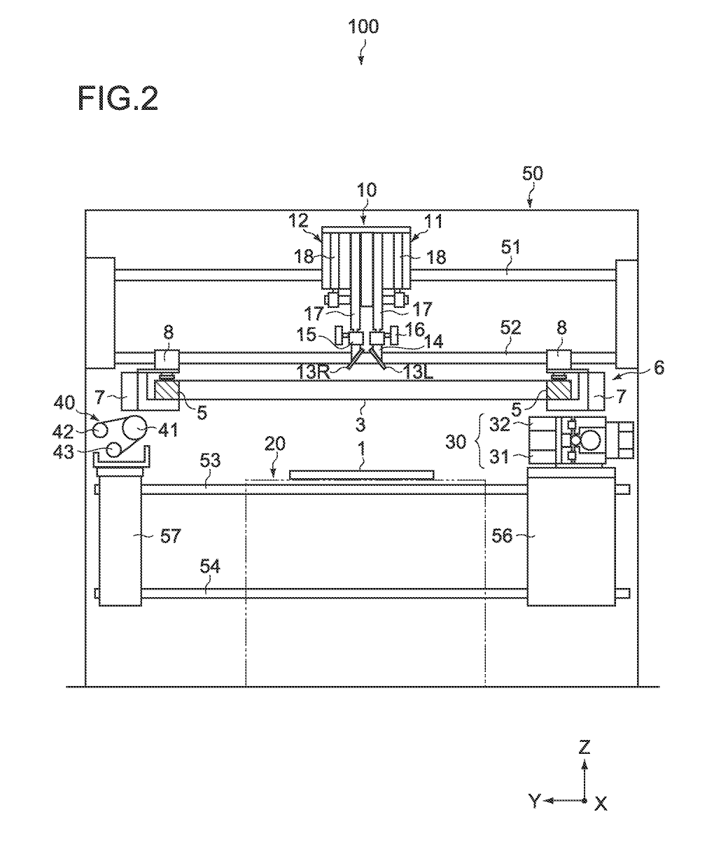

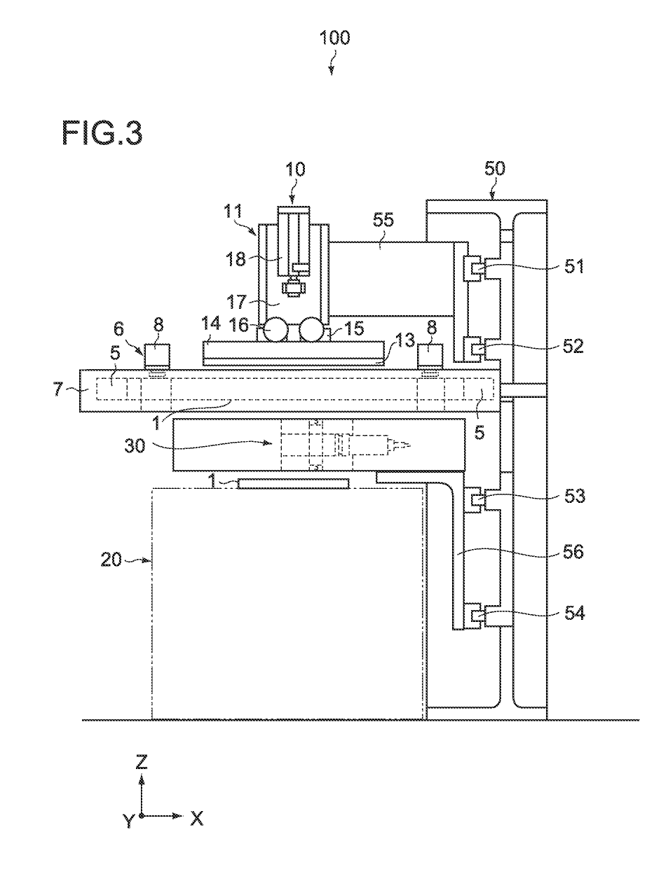

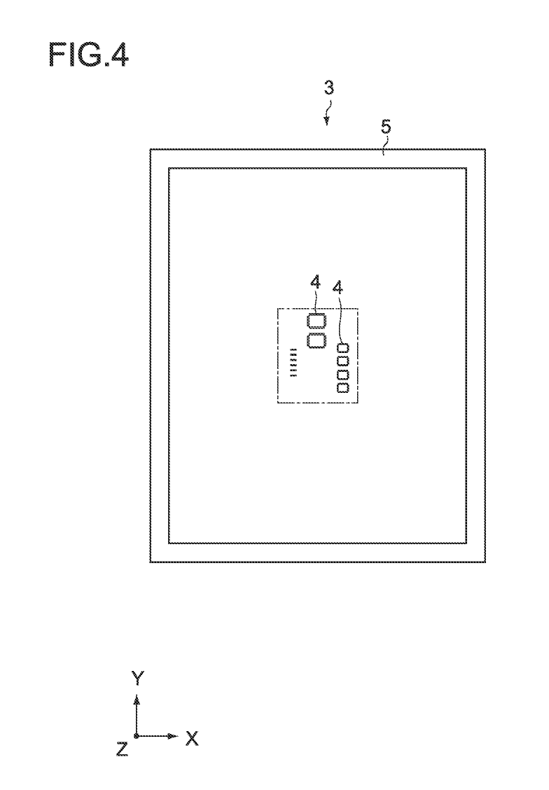

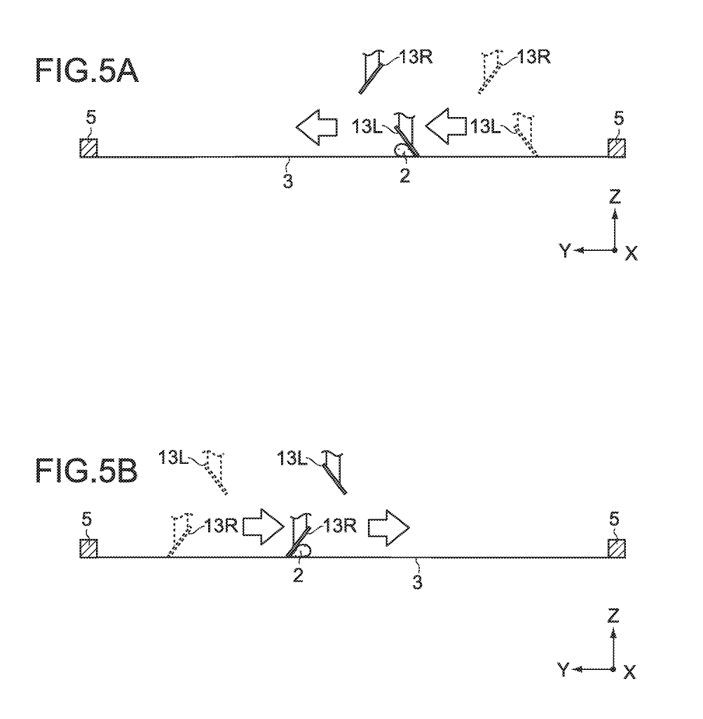

First, the configuration of the screen printing apparatus 100 will be described. FIG. 2 is a front view of the screen printing apparatus 100 according to this embodiment. FIG. 3 is a side view of the screen printing apparatus 100. FIG. 4 is a top view of a screen 3 of the screen printing apparatus 100. FIGS. 5A and 5B are side views of the screen printing apparatus 100, each showing a state in which the solder 2 is being printed on the substrate 1 by a squeegee 13.

As shown in those figures, the screen printing apparatus 100 includes the screen 3, a fixing unit 6, and a squeegee unit 10. The fixing unit 6 fixes the screen 3 to the screen printing apparatus 100 at a predetermined position. The squeegee unit 10 is arranged above the screen 3. Further, the screen printing apparatus 100 includes a positioning unit 20, an imaging unit 30, and a cleaning unit 40, which are arranged below the screen 3. Furthermore, the screen printing apparatus 100 includes a support base 50 that movably supports the squeegee unit 10, the imaging unit 30, and the cleaning unit 40 on the rear side of the screen printing apparatus 100.

The screen 3 includes patterned holes 4 corresponding to a print pattern (see FIG. 4). The screen 3 is made of metal such as stainless steel. The screen 3 is provided with a frame body 5 that imparts a tensile force to the screen 3 along the four sides of the screen 3.

Alignment marks for alignment with the substrate 1 are provided at two positions on a lower surface of the screen 3. In accordance therewith, alignment marks for alignment with the screen 3 are also provided at two positions on the substrate 1.

The fixing unit 6 that fixes the screen 3 includes an attachment frame 7 and four screen clamps 8. The four screen clamps 8 are provided to the attachment frame 7 and sandwiches the frame body 5 of the screen 3 in a vertical direction to fix the frame body 5. The attachment frame 7 is supported by the support base 50, a support member (not shown), and the like.

A pair of guide rails 51 and 52 are provided on the upper side of the support base 50 along a Y-axis direction. Further, a pair of guide rails 53 and 54 are provided on the lower side of the support base 50 along the Y-axis direction.

A carriage 55 that supports the squeegee unit 10 is movably attached to the guide rails 51 and 52. The carriage 55 and the squeegee unit 10 supported by the carriage 55 are moved along the Y-axis direction with respect to the support base 50 by, for example, the drive of a drive mechanism constituted of a ball screw, a motor, and the like.

The squeegee unit 10 includes a first squeegee mechanism 11 and a second squeegee mechanism 12 arranged symmetrically with the first squeegee mechanism 11. Each of the first squeegee mechanism 11 and the second squeegee mechanism 12 includes a squeegee 13, a squeegee holding member 14, a coupling bracket 15, a support member 17, and an air cylinder 18.

The squeegee 13 slides on the screen 3 to which the solder 2 is supplied, and the solder 2 is thus printed on the substrate 1 through the patterned holes 4 provided to the screen 3. Thus, a plurality of soldered parts 2 are obtained. Hereinafter, the solder 2 is also referred to as a soldered part 2 in description of the solder 2 after printing. In this specification, in the case where the squeegee 13 of the first squeegee mechanism 11 and that of the second squeegee mechanism 12 are particularly distinguished from each other, the squeegee 13 of the first squeegee mechanism 11 is referred to as a first squeegee 13L, and the squeegee 13 of the second squeegee mechanism 12 is referred to as a second squeegee 13R. The first squeegee 13L slides in the leftward direction and the second squeegee 13R slides in the rightward direction when viewed from the front of the screen printing apparatus 100.

The squeegee 13 is held by the squeegee holding member 14. The squeegee holding member 14 is attached to the support member 17 via the coupling bracket 15. The coupling bracket 15 and the support member 17 are screwed with a screw 16. The support member 17 is attached to a movable part of the air cylinder 18. The air cylinder 18 moves the support member 17, the coupling bracket 15, the squeegee holding member 14, and the squeegee 13 integrally in the vertical direction by the drive of the movable part.

With reference to FIGS. 5A and 5B, the first squeegee 13L and the second squeegee 13R slide on the screen 3 in the different slide directions, i.e., the leftward direction and the rightward direction, respectively, so that the solder 2 is printed on the different substrates 1. When the first squeegee 13L is printing the solder 2 on the substrate 1 by sliding on the screen 3, the second squeegee 13R is located above the screen 3 and is not brought into contact with the screen 3. On the other hand, when the second squeegee 13R is printing the solder 2 on the substrate 1 by sliding on the screen 3, the first squeegee 13L is located above the screen 3 and is not brought into contact with the screen 3. The squeegee 13 that slides on the screen 3 is alternately switched.

The positioning unit 20 positions the substrate 1 to be subjected to screen printing with respect to the screen 3. The positioning unit 20 includes a conveyer, a suction stage, an up-and-down mechanism, a table mechanism, and the like, which are not shown. The conveyer conveys the substrate 1. The suction stage sucks and holds the substrate 1. The up-and-down mechanism moves up and down the suction stage. The table mechanism moves the suction stage in X-, Y-, and θ-axis directions.

The positioning unit 20 holds the substrate 1 with the suction stage and moves the suction stage holding the substrate 1 in the X-, Y-, and θ-axis directions by the table mechanism to accurately align the position of the substrate 1 with the position of the screen 3. After that, the positioning unit 20 moves the suction stage holding the substrate 1 in an upward direction by the up-and-down mechanism so that the substrate 1 is brought into contact with the lower surface of the screen 3. In this state, one of the first squeegee 13L and the second squeegee 13R slides on the screen 3. Thus, soldered parts 2 corresponding to the patterned holes 4 provided to the screen 3 are printed on the substrate 1.

After the solder 2 is printed on the substrate 1, the positioning unit 20 moves the suction stage in a downward direction by the up-and-down mechanism so that the substrate 1 is separated from the lower surface of the screen 3. After that, the positioning unit 20 conveys the substrate 1 by the conveyer to transfer the substrate 1 to the printing inspection apparatus 200 arranged downstream of the screen printing apparatus 100.

A carriage 56 that supports the imaging unit 30 and a carriage 57 that supports the cleaning unit 40 are movably attached to the guide rails 53 and 54 in the Y-axis direction. The guide rails 53 and 54 are provided on the lower side of the support base 50.

The carriage 56 and the imaging unit 30 supported by the carriage 56 are moved along the Y-axis direction with respect to the support base 50 by the drive of a drive mechanism such as a ball screw and a motor. The imaging unit 30 is attached to be movable with respect to the carriage 56 in the X-axis direction, and is moved along the X-axis direction with respect to the carriage 56 by the drive of the drive mechanism such as a ball screw and a motor. Thus, the imaging unit 30 is movable along the Y-axis direction and the X-axis direction.

The imaging unit 30 includes a first imaging unit 31 directed toward the lower side and a second imaging unit 32 directed toward the upper side. The first imaging unit 31 directed toward the lower side images an alignment mark provided onto the substrate 1. The second imaging unit 32 directed toward the upper side images an alignment mark provided on the lower surface of the screen 3. The screen 3 and the substrate 1 are aligned with each other based on images of the alignment marks captured by the first imaging unit 31 and the second imaging unit 32.

Each of the first imaging unit 31 and the second imaging unit 32 includes an imaging device such as a CCD (Charge Coupled Device) sensor and a CMOS (Complementary Metal Oxide Semiconductor) sensor and an optical system such as an imaging lens.

The carriage 57 and the cleaning unit 40 supported by the carriage 57 are moved along the Y-axis direction with respect to the support base 50 by the drive of a drive mechanism such as a ball screw and a motor. The cleaning unit 40 includes a roller 41, a feed roller 42 that feeds a cleaning tape, and a take-up roller 43 that takes up the cleaning tape.

When the cleaning unit 40 is moved along the Y-axis direction, in conjunction therewith, the roller 41, the feed roller 42, and the take-up roller 43 are rotated. The cleaning tape that is fed from the feed roller 42 rotates along the circumference of the roller 41 while being in contact with the lower surface of the screen 3, and then taken up by the take-up roller 43. Thus, the lower surface of the screen 3 is cleaned.

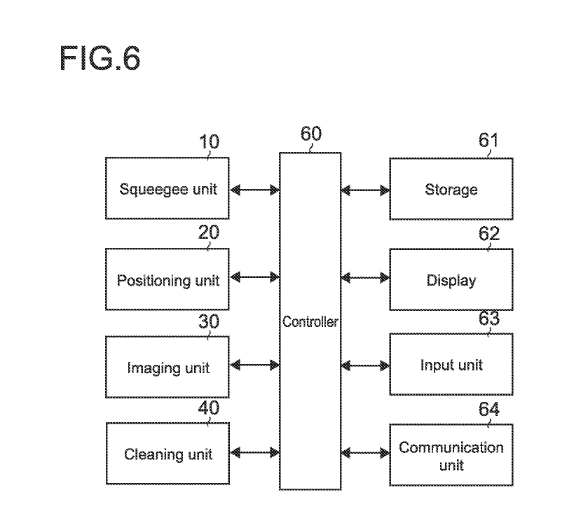

FIG. 6 is a block diagram showing the configuration of the screen printing apparatus 100. As shown in FIG. 6, the screen printing apparatus 100 includes a controller 60, a storage 61, a display 62, an input unit 63, and a communication unit 64, in addition to the squeegee unit 10, the positioning unit 20, the imaging unit 30, the cleaning unit 40, and the like described above.

The controller 60 is constituted of, for example, a CPU (Central Processing Unit) and the like and performs overall control on the units of the screen printing apparatus 100. The storage 61 includes a non-volatile memory used as a work area of the controller 60, and a non-volatile memory in which various programs necessary for processing of the controller 60 are stored. The various programs described above may be read from portable recording media such as an optical disc and a semiconductor memory.

The display 62 is constituted of a liquid crystal display, for example. The input unit 63 is constituted of a keyboard, a mouse, a touch panel, and the like and is used for inputting an instruction from a user. The communication unit 64 transmits information to the printing inspection apparatus 200 or another apparatus such as the mounting apparatus, or receives information from the printing inspection apparatus 200 or another apparatus such as the mounting apparatus.

(Configuration of Printing Inspection Apparatus 200)

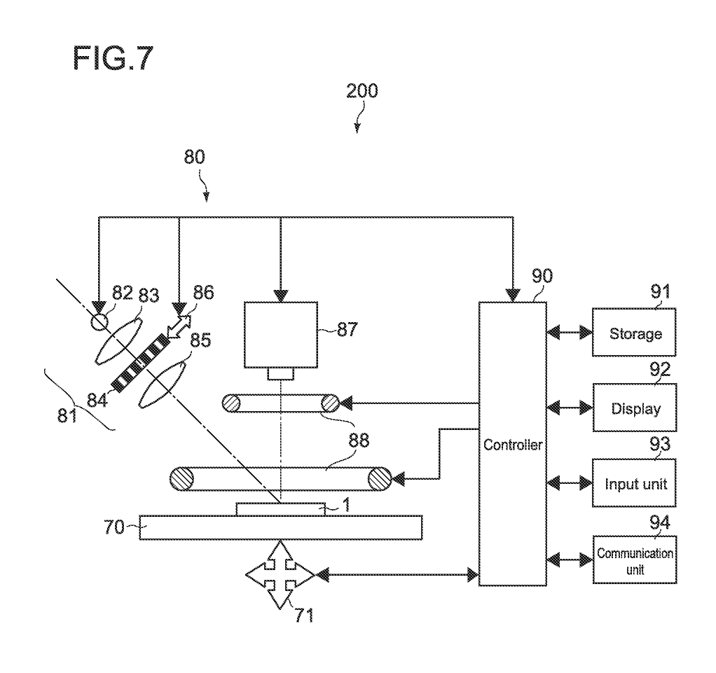

Next, the configuration of the printing inspection apparatus 200 will be described. FIG. 7 is a diagram showing the configuration of the printing inspection apparatus 200.

The printing inspection apparatus 200 inspects the printed state of the soldered part 2 by performing three-dimensional coordinate measuring on the soldered part 2. In this embodiment, a case of using a phase shift method will be described as an example of a method of performing three-dimensional coordinate measuring on the soldered part 2. It should be noted that the method of performing three-dimensional coordinate measuring on the soldered part 2 is not limited to the phase shift method, and other methods such as laser light scanning, laser light sectioning, and a focusing method may be used.

As shown in FIG. 7, the printing inspection apparatus 200 includes a stage 70, a stage-moving mechanism 71, a measurement unit 80, a controller 90, a storage 91, a display 92, an input unit 93, and a communication unit 94.

The substrate 1 on which the soldered parts 2 are printed with the screen printing apparatus 100 is disposed on the stage 70. The stage-moving mechanism 71 is electrically connected to the controller 90 and moves the stage 70 in the X, Y, and Z directions in accordance with a drive signal transmitted from the controller 90.

The measurement unit 80 includes a projection unit 81, an imaging unit 87, and a lighting unit 88. The projection unit 81 projects a sinusoidal fringe pattern onto the substrate 1. The imaging unit 87 images the substrate 1 onto which the fringe pattern is projected. The lighting unit 88 irradiates the substrate 1 with light. The measurement unit 80 measures the soldered part 2 printed on the substrate 1.

The projection unit 81 includes a light source 82, a focusing lens 83, a diffraction grating 84, and a projection lens 85. The focusing lens 83 focuses light from the light source 82. The diffraction grating 84 diffracts the light focused by the focusing lens 83. The projection lens 85 projects the light diffracted by the diffraction grating 84 onto the substrate 1.

The diffraction grating 84 has a plurality of slits, and diffracts the light from the light source 82 and projects onto the substrate 1 a fringe pattern whose luminance changes in a sinusoidal manner. The diffraction grating 84 is provided with a grating moving mechanism 86 to move the diffraction grating 84 in a direction orthogonal to the direction in which the slits are formed. The grating moving mechanism 86 moves the diffraction grating 84 and shifts a phase of the fringe pattern projected onto the substrate 1 under the control of the controller 90.

The lighting unit 88 irradiates the substrate 1 with light. The lighting unit 88 includes two annular lightings, for example.

The imaging unit 87 includes an imaging device such as a CCD sensor and a CMOS sensor, and an optical system including an imaging lens and the like. The imaging lens forms an image of light from the substrate 1 on an imaging surface of the imaging device.

The controller 90 is constituted of a CPU, for example. The controller 90 performs overall control on the printing inspection apparatus 200 based on various programs stored in the storage 91. The storage 91 includes a non-volatile memory in which various programs necessary for processing of the printing inspection apparatus 200 are stored, and a volatile memory used as a work area of the controller 90. The various programs described above may be read from portable recording media such as an optical disc and a semiconductor memory.

The display 92 is constituted of a liquid crystal display, for example. The display 92 displays inspection data of the soldered part 2 and the like under the control of the controller 90. The input unit 93 is constituted of a keyboard, a mouse, a touch panel, and the like and is used for inputting an instruction from a user. The communication unit 94 transmits information to the screen printing apparatus 100 or another apparatus such as a mounting apparatus, or receives information from the screen printing apparatus 100 or another apparatus such as the mounting apparatus.

(Three-Dimensional Coordinate Measuring)

Next, three-dimensional coordinate measuring for the soldered part 2 will be described.

The controller 90 disposes the substrate 1, which is transferred from the screen printing apparatus 100, onto the stage 70. Then, the controller 90 moves the stage 70 by the stage-moving mechanism 71 to dispose the substrate 1 at a predetermined position. Then, the controller 90 controls the projection unit 81 to project onto the substrate 1 a fringe pattern whose luminance changes in a sinusoidal manner and controls the imaging unit 87 to image the substrate 1 on which the fringe pattern is projected.

After the imaging unit 87 images the substrate 1 on which the fringe pattern is projected, the controller 90 then controls the grating moving mechanism 86 to shift a phase of the fringe pattern projected onto the substrate 1 by π/2[rad]. Then, the controller 90 controls the imaging unit 87 to image again the substrate 1 on which the fringe pattern is projected. After that, the controller 90 repeats twice the operation of shifting the phase of the fringe pattern by π/2[rad] and imaging the substrate 1 by the imaging unit 87. Thus, a total of four images with phases of the fringe pattern of 0, π/2, n, and 3π/2 are acquired.

The controller 90 extracts a luminance value of each pixel from the acquired four images and obtains a phase φ(x,y) at corresponding coordinates (x,y) on the substrate 1. If a phase φ(x,y) is obtained, the height at the corresponding coordinates (x,y) on the substrate 1 can be obtained based on the phase φ(x,y) according to the principle of triangulation. The controller 90 can obtain the position, height, area, volume, and the like of the soldered part 2 based on the height of the coordinates corresponding thereto on the substrate 1.

By such a method, the controller 90 can obtain inspection data of the soldered part 2 (position, height, area, and volume of the solder 2) based on the four images (measured data of the soldered part 2 obtained by the measurement unit 80).

(Determination Method for Slide Direction of Squeegee 13)

In addition to the processing described above, the controller 90 executes processing of determining a slide direction of the squeegee 13 based on the four images (measured data of the soldered part 2 obtained by the measurement unit 80) or statistical processing of inspection data for each slide direction of the squeegee 13. Hereinafter, such processing will be described.

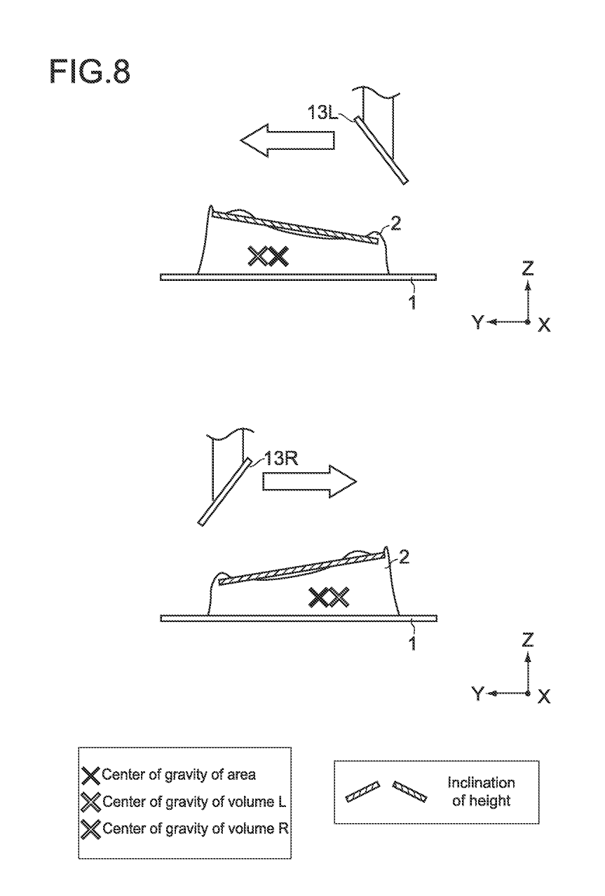

Here, a determination method for the slide direction of the squeegee 13 will first be described. FIG. 8 is a diagram for describing the determination method for the slide direction of the squeegee 13. As shown in the upper part of FIG. 8, a case where the solder 2 is printed on the substrate 1 with the first squeegee 13L whose slide direction is leftward will be described. In this case, as shown in the upper part of FIG. 8, the height of the soldered part 2 is lowest on the right side and gradually increases from the right side toward the left side to be highest on the left side. For that reason, the soldered part 2, which is printed with the first squeegee 13L whose slide direction is leftward, has the center of gravity of a volume at a position shifted to the left relative to the center of gravity of an area.

On the other hand, as shown in the lower part of FIG. 8, a case where the solder 2 is printed on the substrate 1 with the second squeegee 13R whose slide direction is rightward will be described. In this case, as shown in the lower part of FIG. 8, the height of the soldered part 2 is lowest on the left side and gradually increases from the left side toward the right side to be highest on the right side. For that reason, the soldered part 2, which is printed with the second squeegee 13R whose slide direction is rightward, has the center of gravity of a volume at a position shifted to the right relative to the center of gravity of an area.

In the present disclosure, this relation is used to determine the slide direction of the squeegee 13 with which the solder 2 is printed on the substrate 1.

The processing performed when the controller 90 determines the slide direction of the squeegee 13 will be specifically described.

First, the controller 90 calculates a position of the center of gravity of an area of the soldered part 2 and a position of the center of gravity of a volume of the soldered part 2, based on the inspection data of the soldered part 2, which is calculated based on the measured data (four images) acquired by the measurement unit 80. In this case, the controller 90 calculates the position of the center of gravity of the area of the soldered part 2 based on area data of the soldered part 2 and calculates the position of the center of gravity of the volume of the soldered part 2 based on volume data of the soldered part 2. The area data and the volume data are included in the inspection data of the soldered part 2 (position, height, area, and volume of the soldered part 2).

Then, the controller 90 determines the slide direction of the squeegee 13 that prints the above-mentioned soldered part 2 based on the position of the center of gravity of the volume and the position of the center of gravity of the area. At that time, the controller 90 calculates a difference between the position of the center of gravity of the area and the position of the center of gravity of the volume. Then, the controller 90 determines to which of the right side or left side the position of the center of gravity of the volume is shifted relative to the center of gravity of the area, to thereby determine the slide direction of the squeegee 13. In other words, when the position of the center of gravity of the volume is shifted to the left side relative to the center of gravity of the area (see the upper part of FIG. 8), the controller 90 can determine that the slide direction of the squeegee 13 is leftward. On the other hand, when the position of the center of gravity of the volume is shifted to the right side relative to the center of gravity of the area (see the lower part of FIG. 8), the controller 90 can determine that the slide direction of the squeegee 13 is rightward.

It should be noted that as shown in the upper part and lower part of FIG. 8, the difference in features of the soldered part 2 due to the slide direction of the squeegee 13 is found in the inclination of the height of the soldered part 2, in addition to the position of the center of gravity of the volume relative to the center of gravity of the area. The controller 90 may determine the slide direction of the squeegee 13 based on the inclination of the height of the soldered part 2. In this case, the controller 90 calculates the inclination of the soldered part 2 based on the height of the soldered part 2. When the inclination is diagonally right down, the controller 90 determines that the slide direction of the squeegee 13 is leftward. When the inclination is diagonally left down, the controller 90 determines that the slide direction of the squeegee 13 is rightward.

A plurality of soldered parts 2 are formed on the substrate 1. When determining the slide direction of the squeegee 13, the controller 90 may determine the slide direction of the squeegee 13 by the measurement of one of the plurality of soldered parts 2 or by the measurement of two or more soldered parts 2.

The inventors of the present disclosure prepared the screen 3 with the patterned holes 4 having the size of about 0.5×0.5 mm to 2.0×2.0 mm and used this screen 3 to print the solder 2 on the substrate 1. Then, the inventors of the present disclosure determined the slide direction of the squeegee 13 for the soldered parts 2 (about 0.5×0.5 mm to 2.0×2.0 mm) printed on the substrate 1, by using the printing inspection apparatus 200.

At that time, the slide direction of the squeegee 13 was determined by the measurement of one of the soldered parts 2. The difference in features of the soldered part 2 due to the slide direction of the squeegee 13 was clearly found for each slide direction of the squeegee 13, with the result that erroneous determination hardly occurred. In other words, even when the number of soldered parts 2 is one, the slide direction of the squeegee 13 can be accurately determined. Therefore, typically, it is effective to execute the processing of determining the slide direction of the squeegee 13 by the measurement of one of the plurality of soldered parts 2.

On the other hand, for example, it may be thought that the difference in features of the soldered part 2 due to the slide direction of the squeegee 13 is reduced by the further smaller size of the patterned holes 4 formed on the screen 3. In such a case, the slide direction of the squeegee 13 may be determined by the measurement of two or more soldered parts 2 out of the plurality of soldered parts 2 formed on the substrate 1. Accordingly, the accuracy of the determination on the slide direction of the squeegee 13 can be increased.

(Statistical Method of Obtaining Inspection Data for Each Slide Direction of Squeegee 13 and Method of Utilizing Inspection Data Obtained for Each Slide Direction of Squeegee 13)

Next, a statistical method of obtaining inspection data for each slide direction of the squeegee 13, and a method of utilizing inspection data obtained for each slide direction of the squeegee 13 (statistical data for each slide direction of squeegee 13) will be described.

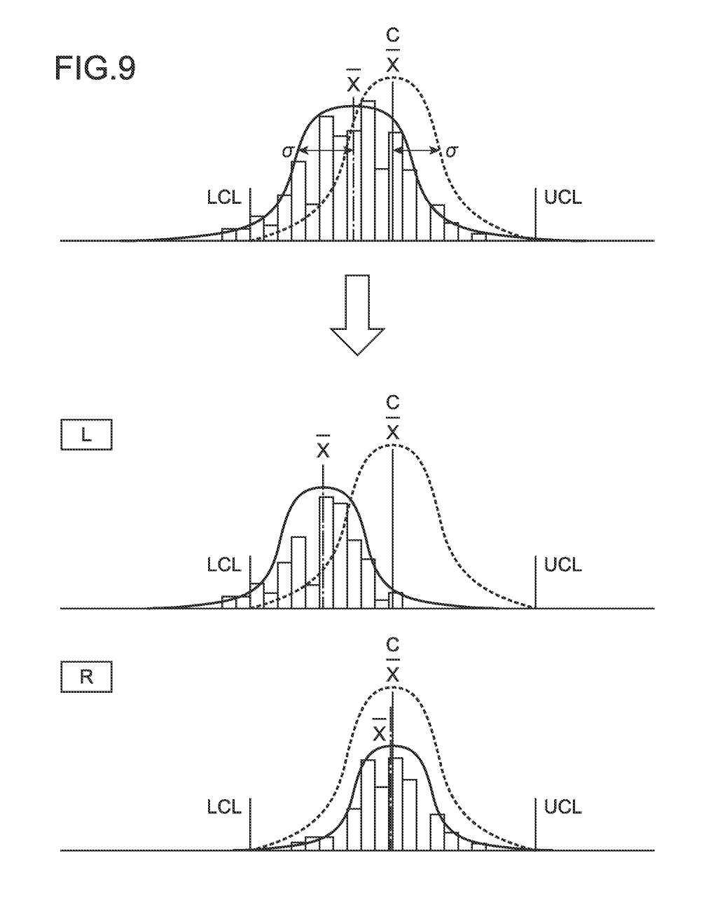

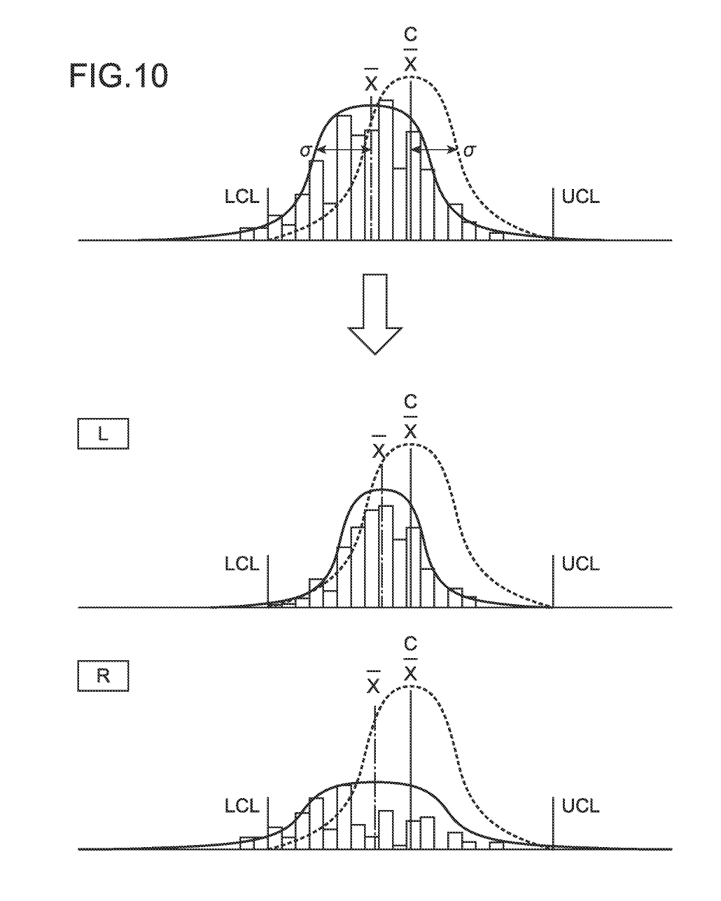

FIGS. 9 and 10 are diagrams for comparison between inspection data of the soldered parts 2, which is obtained without consideration of the slide direction of the squeegee 13 (Comparative Example), and inspection data of the soldered parts 2, which is obtained in consideration of the slide direction of the squeegee 13 (this embodiment). The upper parts of FIGS. 9 and 10 each show an example in which the inspection data of the soldered parts 2 printed with the first squeegee 13L and the inspection data of the soldered parts 2 printed with the second squeegee 13R are obtained in a mixed manner without consideration of the slide direction of the squeegee 13. The middle and lower parts of FIG. 9 and the middle and lower parts of FIG. 10 each show an example in which the inspection data of the soldered parts 2 printed with the first squeegee 13L and the inspection data of the soldered parts 2 printed with the second squeegee 13R are separately obtained in consideration of the slide direction of the squeegee 13.

It should be noted that in the statistical data shown in FIGS. 9 and 10, the horizontal axis indicates a volume (quantity) of the soldered part 2, and the vertical axis indicates the number of soldered parts 2. A curved line indicated by a broken line indicates an ideal distribution of the volume of the soldered part 2. Further, a symbol of X with bar indicates an average value of the volume of the soldered part 2. σ indicates a standard deviation. A UCL (Upper Control Limit) indicates an upper control limit line. An LCL (Lower Control Limit) indicates a lower control limit line.

As shown in the upper parts of FIGS. 9 and 10 (Comparative Example), it is found that the distribution of the volume of the soldered part 2 is shifted to the left as a whole and there are soldered parts 2 whose volumes are lower than the LCL. Based on this fact, it is found that a printing failure occurs due to the shortage of the volume of the soldered parts 2 printed on the substrate 1. Further, as shown in the upper part of FIG. 9, it is also found that the dispersion of the volume of the soldered part 2 (standard deviation σ) is large. In Comparative Example shown in the upper parts of FIGS. 9 and 10, however, the inspection data of the soldered parts 2 is not obtained for each slide direction of the squeegee 13. Therefore, it is difficult to identify a cause of the shortage of the solder 2.

On the other hand, as shown in the middle and lower parts of FIG. 9 and the middle and lower parts of FIG. 10, in this embodiment, the volume of the soldered part 2 (inspection data) is obtained for each slide direction of the squeegee 13. In other words, the volume of the soldered part 2 printed on the substrate 1 with the first squeegee 13L that slides on the screen 3 in the leftward direction, which is shown in the middle parts of FIGS. 9 and 10, is obtained separately from the volume of the soldered part 2 printed on the substrate 1 with the second squeegee 13R that slides on the screen 3 in the rightward direction, which is shown in the lower parts of FIGS. 9 and 10.

To execute the statistical processing for each slide direction of the squeegee 13 as shown in the middle and lower parts of FIG. 9 and the middle and lower parts of FIG. 10, the controller 90 of the printing inspection apparatus 200 executes statistical processing of the inspection data of the soldered parts 2 for each slide direction of the squeegee 13, the slide direction being determined by the determination method described above. The statistical processing of the inspection data of the soldered parts 2 is executed by storing the inspection data of the soldered parts 2 for a plurality of substrates 1. Here, the plurality of soldered parts 2 are printed on the substrate 1. Therefore, the controller 90 typically reflects the inspection data of all the soldered parts 2 printed on the substrate 1 on the statistical data.

The inspection data includes data of a position, height, area, volume, and the like of the soldered part 2 measured by the above-mentioned three-dimensional coordinate measuring. An example of a case where the data of the volume of the soldered part 2 in the inspection data is obtained for each slide direction of the squeegee 13 is shown in each of the middle and lower parts of FIG. 9 and the middle and lower parts of FIG. 10. The controller 90 obtains the data of the volume of the soldered part 2 for each slide direction of the squeegee 13 and displays statistical data for each slide direction of the squeegee 13 as shown in the middle and lower parts of FIG. 9 and the middle and lower parts of FIG. 10, on a monitor of the display 92.

With reference to the middle part of FIG. 9, it is found that the distribution of the volume of the soldered part 2 is shifted to the left as a whole and there are soldered parts 2 whose volumes are lower than the LCL. Therefore, an operator can determine that the volume of the soldered part 2 printed with the first squeegee 13L that slides on the screen 3 in the leftward direction is deficient, by visually recognizing the statistical data shown in the middle part of FIG. 9, which is displayed on the display 92.

On the other hand, in the lower part of FIG. 9, an abnormality is not found in the distribution of the volume of the soldered part 2. Therefore, the operator can determine that the volume of the soldered part 2 printed with the second squeegee 13R that slides on the screen 3 is normal, by visually recognizing the statistical data shown in the lower part of FIG. 9, which is displayed on the display 92.

Based on those pieces of statistical data, the operator can first determine that a cause of the printing failure results not from the second squeegee 13R but from the first squeegee 13L. This fact is difficult to be found in the upper part of FIG. 9 according to Comparative Example. Further, in the case where the distribution of the volume of the soldered part 2 is shifted to the left as a whole as shown in the middle part of FIG. 9, the operator can identify a specific candidate of the cause of the printing failure based on the distribution. In general, in the case where a printing pressure of the squeegee 13 is excessively large, the distribution of the volume of the soldered part 2 is shifted to the left as a whole in many cases, as shown in the middle part of FIG. 9. Therefore, the operator can determine that an excessive printing pressure of the squeegee 13 is one of candidates of the cause of the printing failure, i.e., the shortage of the volume of the soldered part 2.

Based on such an analysis, the operator adjusts the printing pressure of the first squeegee 13L so as to reduce the printing pressure of the first squeegee 13L. Thus, the cause of the printing failure is adequately eliminated. The printing pressure of the squeegee 13 can be adjusted by changing the control of the air cylinder 18 configured to move the squeegee 13 in the vertical direction, for example.

With reference to the middle part of FIG. 10, it is found that there are no soldered parts 2 whose volumes are lower than the LCL, but the distribution of the volume of the soldered part 2 is shifted to the left as a whole. Therefore, the operator can determine that a printing failure occurs due to the shortage of the volume of the soldered part 2 that results from the first squeegee 13L, and identify the cause of this printing failure, which is an excessive printing pressure of the squeegee 13. In this case, the operator only needs to adjust the printing pressure of the first squeegee 13L so as to reduce the printing pressure of the first squeegee 13L, as in the case of the middle part of FIG. 9.

It is found in the lower part of FIG. 10 that the dispersion of the volume of the soldered part 2 is large, and an average value of the volume of the soldered part 2 is shifted to the left relative to an ideal average value and the volume of the soldered part 2 is deficient. Based on this fact, the operator first recognizes that the printing failure resulting from the second squeegee 13R occurs. Further, in the case where the dispersion of the volume of the soldered part 2 is large as shown in the lower part of FIG. 10, the operator can identify a specific candidate of the cause of the printing failure based on the dispersion.

In general, in the case where the printing pressure of the squeegee 13 varies or is unstable due to an increase or decrease of the printing pressure applied when the squeegee 13 slides on the screen 3, the dispersion of the volume of the soldered part 2 may be large in many cases as shown in the lower part of FIG. 10. Such variation of the printing pressure of the squeegee 13 may result from an operation failure of the air cylinder 18 that moves the squeegee 13 in the vertical direction. Therefore, in such a case, the operator can determine that the operation failure of the air cylinder 18 is one of candidates of the cause of the printing failure.

Based on such an analysis, the operator only needs to replace the air cylinder 18 with a new one or with a servo motor. Thus, the cause of the printing failure is adequately eliminated.

With reference to the middle parts of FIGS. 9 and 10, the case where the distribution of the volume of the soldered part 2 is shifted to the left as a whole and the soldered part 2 is deficient has been described. On the other hand, a case where the distribution of the volume of the soldered part 2 is shifted to the right as a whole and the volume of the soldered part 2 is excessive is also assumed in the cases of the middle parts of FIGS. 9 and 10, for example. In such a case, the operator can determine that the shortage of the printing pressure of the first squeegee 13L, i.e., an excessive volume of the soldered part 2, is one of candidates of the cause of the printing failure. In such a case, the operator adjusts the printing pressure of the squeegee 13 so as to increase the printing pressure of the first squeegee 13L by changing the control of the air cylinder 18. Thus, the cause of the printing failure is adequately eliminated.

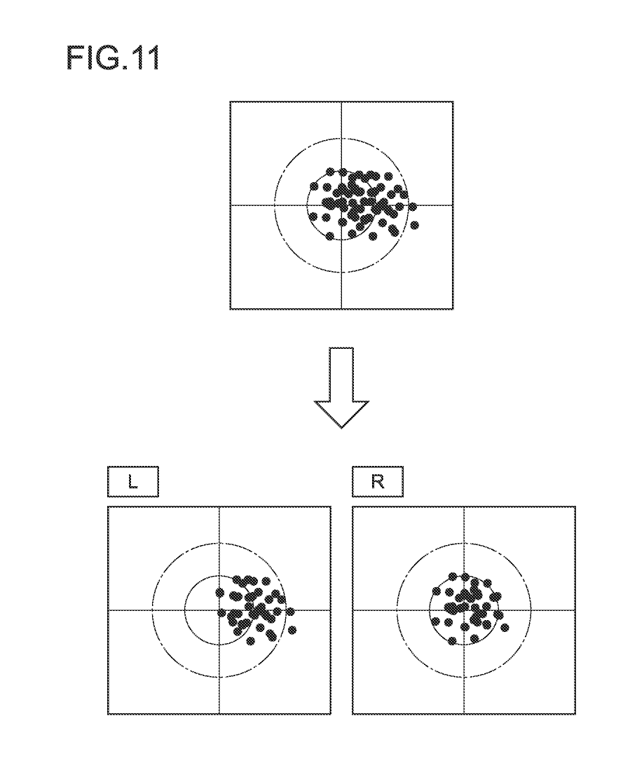

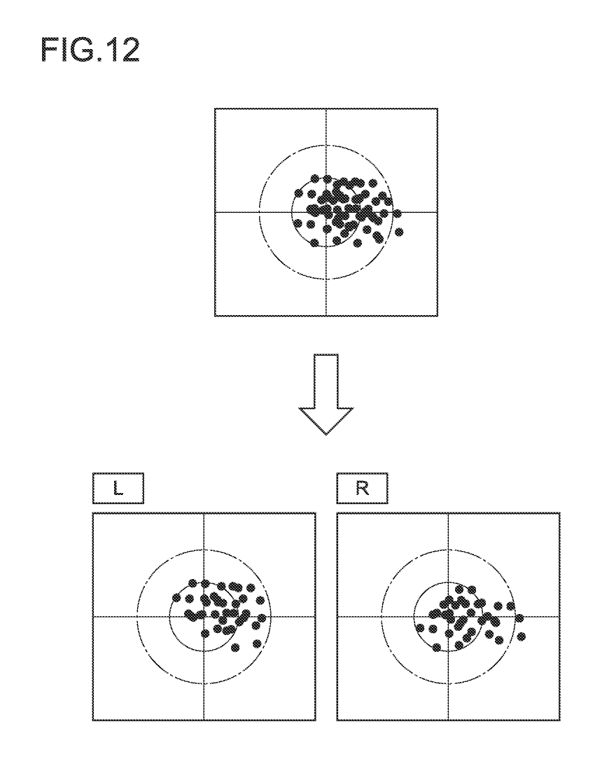

FIGS. 11 and 12 are diagrams for comparison between inspection data of the soldered parts 2, which is obtained without consideration of the slide direction of the squeegee 13 (Comparative Example), and inspection data of the soldered parts 2, which is obtained in consideration of the slide direction of the squeegee 13 (this embodiment). The upper part of FIG. 11 and the upper part of FIG. 12 each show an example in which the inspection data of the soldered parts 2 printed with the first squeegee 13L and the inspection data of the soldered parts 2 printed with the second squeegee 13R are obtained in a mixed manner without consideration of the slide direction of the squeegee 13. The lower left of FIG. 11, the lower right of FIG. 11, the lower left of FIG. 12, and the lower right of FIG. 12 each show an example in which the inspection data of the soldered parts 2 printed with the first squeegee 13L and the inspection data of the soldered parts 2 printed with the second squeegee 13R are separately obtained in consideration of the slide direction of the squeegee 13.

In FIGS. 9 and 10 described above, an example in which the data of the volume of the soldered part 2 in the inspection data obtained by the three-dimensional coordinate measuring is obtained for each slide direction of the squeegee 13 has been described. Meanwhile, in FIGS. 11 and 12 to be described below, an example in which data of a position of the soldered part 2 (actual position of the soldered part 2 relative to a normal position of the soldered part 2) in the inspection data obtained by the three-dimensional coordinate measuring is obtained for each slide direction of the squeegee 13 will be described.

In statistical data shown in FIGS. 11 and 12, the center of a circle indicates an ideal position of the soldered part 2, and a circle indicated by a dashed line indicates a control value. Further, in FIGS. 11 and 12, each plot indicates an actual position of the soldered part 2, i.e., the amount of a position shift of the soldered part 2. One plot shown in the figures corresponds to an average value of actual positions of all soldered parts 2 printed on one substrate 1. In other words, one plot is drawn for one substrate 1.

As shown in the upper parts of FIGS. 11 and 12 (Comparative Example), it is found that the distribution of the position of the soldered part 2 is shifted to the right as a whole and there are soldered parts 2 whose positions are over the control value (dashed line). Based on this fact, it is found that a printing failure occurs due to the position shift of the soldered part 2 printed on the substrate 1. In Comparative Example shown in the upper parts of FIGS. 11 and 12, however, position data of the soldered part 2 is not obtained for each slide direction of the squeegee 13. Therefore, it is difficult to identify the cause of the positional shift of the soldered parts 2.

On the other hand, as shown in the lower left of FIG. 11, the lower right of FIG. 11, the lower left of FIG. 12, and the lower right of FIG. 12, in this embodiment, the position of the soldered part 2 is obtained for each slide direction of the squeegee 13. In other words, the position of the soldered part 2 printed on the substrate 1 with the first squeegee 13L that slides on the screen 3 in the leftward direction, which is shown in the lower left of FIG. 11 and the lower left of FIG. 12, is obtained separately from the position of the soldered part 2 printed on the substrate 1 with the second squeegee 13R that slides on the screen 3 in the rightward direction, which is shown in the lower right of FIG. 11 and the lower right of FIG. 12.

To execute the statistical processing for each slide direction of the squeegee 13 as shown in the lower left of FIG. 11, the lower right of FIG. 11, the lower left of FIG. 12, and the lower right of FIG. 12, the controller 90 of the printing inspection apparatus 200 executes statistical processing of the position of the soldered part 2 for each slide direction of the squeegee 13, the slide direction being determined by the determination method described above. Then, the controller 90 causes the display 92 to display on a monitor thereof position data of the soldered part 2 for each slide direction of the squeegee 13 as shown in the lower left of FIG. 11, the lower right of FIG. 11, the lower left of FIG. 12, and the lower right of FIG. 12.

With reference to the lower left of FIG. 11, it is found that the distribution of the position of the soldered part 2 is shifted to the right as a whole and there are soldered parts 2 whose positions are over the control value. Therefore, the operator can determine that the position of the soldered part 2 printed with the first squeegee 13L that slides on the screen 3 in the leftward direction is shifted to the right, by visually recognizing the statistical data shown in the lower left of FIG. 11, which is displayed on the display 92.

On the other hand, in the lower right of FIG. 11, it is found that the distribution of the position of the soldered part 2 is within an allowable range. Therefore, the operator can determine that the position of the soldered part 2 printed with the second squeegee 13R that slides on the screen 3 in the rightward direction is normal, by visually recognizing the statistical data shown in the lower right of FIG. 11, which is displayed on the display 92.

In the case where the distribution of the position of the soldered part 2 is shifted to the right as a whole as shown in the lower left of FIG. 11, the operator can identify a specific candidate of the cause of the printing failure, i.e., a position shift in printing, based on the distribution. For example, when printing is performed with the first squeegee 13L, if the positioning of the substrate 1 is inaccurate and the position of the substrate 1 is shifted to the left relative to the screen 3, the distribution of the position of the soldered part 2 is shifted to the right as a whole in many cases, as shown in the lower left of FIG. 12. Therefore, the operator can determine that the inaccurate positioning of the substrate 1 is one of candidates of the cause of the printing failure, i.e., a position shift of the soldered part 2.

Based on such an analysis, the operator corrects the position of the substrate 1 toward the right, the substrate 1 being set when the solder 2 is printed on the substrate 1 with the first squeegee 13L. This correction is executed by adjusting an offset value when the solder 2 is printed with the first squeegee 13L.

Here, the position of the substrate 1 relative to the screen 3 at a time when the solder 2 is printed on the substrate 1 with the first squeegee 13L is different from the position of the substrate 1 relative to the screen 3 at a time when the solder 2 is printed on the substrate 1 with the second squeegee 13R. This is because the position of the solder 2 printed on the substrate 1 with the first squeegee 13L that slides in the rightward direction is slightly shifted to the right, and the position of the solder 2 printed on the substrate 1 with the second squeegee 13R that slides in the leftward direction is slightly shifted to the left. In view of the shift amounts of the solder 2, offset values based on the center are set for the case of printing the solder 2 with the first squeegee 13L and the case of printing the solder 2 with the second squeegee 13R. The above-mentioned correction of the position of the substrate 1 relative to the screen 3 can be adjusted by the correction of the offset values.

With reference to the lower left of FIG. 12, it is found that the distribution of the position of the soldered part 2 is shifted to the right as a whole. Similarly, it is also found in the lower right of FIG. 12 that the distribution of the position of the soldered part 2 is shifted to the right as a whole. The operator can determine that the position shift of the soldered part 2 occurs in both the cases of the first squeegee 13L and the second squeegee 13R, by visually recognizing the statistical data shown in the lower left and the lower right of FIG. 12, which is displayed on the display 92. Further, based on the statistical data shown in the lower left and the lower right of FIG. 12, the operator can determine that there is no significant difference between the distribution of the position of the soldered part 2 printed with the first squeegee 13L and the distribution of the position of the soldered part 2 printed with the second squeegee 13R.

In the case where the position shift of the soldered part 2 occurs in both the cases of the first squeegee 13L and the second squeegee 13R and there is no difference between the distributions of the soldered parts 2 printed with those squeegees 13, the operator can identify the following three candidates of the cause of the printing failure.

(1) Due to a problem in fixing the screen 3 by the fixing unit 6 of the screen printing apparatus 100 or a problem of the frame body 5 that imparts a tensile force to the screen 3, the screen 3 is moved when the solder is printed. (2) Due to a small suction force of the suction stage of the screen printing apparatus 100, the position of the substrate 1 is shifted at a time of the positioning of the substrate 1 or the printing of the solder 2. (3) The imaging unit 30 of the screen printing apparatus 100 has a problem, and the positioning of the screen 3 and the substrate 1 is thus inaccurate.

For example, the operator investigates those three candidates of the cause of the printing failure in order of high incidence, to thereby identify the cause of the printing failure. Then, the operator only needs to eliminate the identified cause of the printing failure. For example, it is assumed that the screen clamps 8 of the fixing unit 6 sandwich the screen 3 by a weak force and the screen 3 is moved at a time of the printing of the solder. In this case, the operator firmly fixes the screen 3 by using the screen clamps 8 or replaces the screen clamps 8 if the screen clamps 8 are broken. In the case where the frame body 5 that imparts a tensile force to the screen 3 has an abnormality, the operator replaces the frame body 5 with a new one. In the case where a suction force of the substrate suction stage is weak, the operator adjusts a mechanism such as an air compressor for sucking the substrate, to thereby increase a suction force of the suction stage. In the case where the imaging unit 30 has an abnormality, the operator repairs the imaging unit 30 or replaces the imaging unit 30 with a new one.

In the description above, the case where the inspection data obtained for each slide direction of the squeegee 13 is displayed on the display 92 and the operator visually recognizes the inspection data to determine whether the printing failure occurs or not or determine a candidate of the cause of the printing failure has been described. On the other hand, the step of determining whether the printing failure occurs or not or the step of identifying a candidate of the cause of the printing failure can be automated. In the following description, the processing of the controller 90 in such a case will be described.

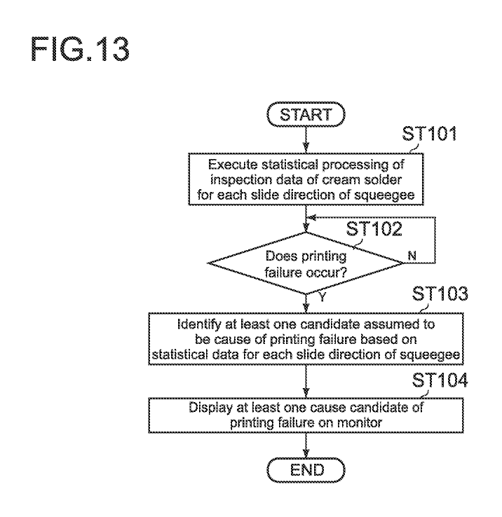

FIG. 13 is a flowchart showing processing of the controller 90 of the printing inspection apparatus 200. It should be noted that the processing of the controller 90 will be specifically described with reference to FIG. 9.

First, the controller 90 of the printing inspection apparatus 200 executes statistical processing of the inspection data of the soldered parts 2 for each slide direction of the squeegee 13 (Step 101). Then, the controller 90 determines whether a printing failure occurs or not based on the inspection data of the soldered parts 2 (Step 102). For example, the controller 90 determines whether a printing failure of the soldered parts 2 occurs or not based on the statistical data of the soldered parts 2 as shown in FIG. 9. The statistical data is not necessarily the statistical data obtained for each slide direction of the squeegee.

For example, in the example shown in FIG. 9, the controller 90 determines how much an average value of the volume (indicated by the symbol of X with bar) is shifted from the center value (indicated by a symbol of C-X with bar) or determines whether there is a soldered part 2 whose volume is out of the range from the LCL to the UCL. Based on those determination results, the controller 90 determines whether a printing failure of the soldered part 2 occurs or not.

When a printing failure is detected (YES in Step 102), the controller 90 proceeds to the next step, Step 103. In Step 103, the controller 90 identifies at least one candidate assumed to be a cause of the printing failure, based on the statistical data obtained for each slide direction of the squeegee 13.

For example, in the examples shown in the middle and lower parts of FIG. 9, based on those pieces of statistical data, the controller 90 first determines that the printing failure results not from the second squeegee 13R but from the first squeegee 13L. Further, in the case where the distribution of the volume of the soldered part 2 is shifted to the left as a whole as shown in the middle part of FIG. 9, the controller 90 determines that an excessive printing pressure of the first squeegee 13L is one of candidates of the cause of the printing failure. It should be noted that when there are a plurality of candidates assumed to be causes of the printing failure (see the description on FIG. 12, for example), the controller 90 identifies a plurality of candidates.

After identifying at least one candidate of the cause of the printing failure, the controller 90 causes the display 92 to display the at least one candidate of the cause of the printing failure on a monitor of the display 92 (Step 104). In the examples shown in the middle and lower parts of FIG. 9, for example, displayed on the monitor of the display 92 is a message of “Printing failure has occurred due to the shortage of the solder 2 printed with the first squeegee 13L. A cause of the printing failure may be an excessive printing pressure of the first squeegee 13L.”

For example, in the case where there are a plurality of candidates assumed to be causes of the printing failure, the controller 90 may execute the processing of displaying candidates that are likely to be causes of the printing failure on the monitor in order of high incidence. Further, the controller 90 may display the causes of the printing failure and display the statistical data obtained for each slide direction of the squeegee 13 on the monitor of the display 92.

The operator checks characters displayed on the monitor of the display 92 and eliminates the cause of the printing failure. For example, in the case where an excessive printing pressure of the first squeegee 13L is indicated as a cause of the printing failure, the operator changes the control of the air cylinder 18 so as to reduce the printing pressure of the first squeegee 13L.

It should be noted that the case where the operator eliminates the cause of the printing failure has been described here, but it is possible to automate the elimination of the cause of the printing failure. In this case, for example, the controller 90 of the printing inspection apparatus 200 identifies at least one candidate of the cause of the printing failure, and then outputs information indicating the identified at least one candidate of a cause to the screen printing apparatus 100 via the communication unit 94. Upon reception of the candidate of the cause of the printing failure via the communication unit 64, the controller 60 of the screen printing apparatus 100 executes the processing of eliminating the cause of the printing failure.

For example, in the case where the cause of the printing failure is determined to be an excessive printing pressure of the first squeegee 13L, the controller 90 of the printing inspection apparatus 200 outputs information indicating an excessive printing pressure of the first squeegee 13L to the screen printing apparatus 100 via the communication unit 94. Upon reception of the information indicating the excessive printing pressure of the first squeegee 13L, the controller 60 of the screen printing apparatus 100 changes the control of the air cylinder 18 so as to reduce the printing pressure of the first squeegee 13L. Thus, the screen printing apparatus 100 allows the cause of the printing failure of the solder 2 to be automatically eliminated.

As described above, in the printing inspection apparatus 200 according to this embodiment, the statistical processing of the inspection data of the soldered parts 2 is executed for each slide direction of the squeegee 13. Accordingly, the operator or computer can easily identify the cause of the printing failure.

### Various Modified Examples

In the above description, the case where the statistical data obtained for each slide direction of the squeegee 13, candidates of the cause of the printing failure, and the like are displayed on the monitor of the display 92 of the printing inspection apparatus 200 has been described. On the other hand, the statistical data obtained for each slide direction of the squeegee 13 and the candidates of the cause of the printing failure may be displayed on the monitor of the display 62 of the screen printing apparatus 100. This is because the printing failure occurs in the screen printing apparatus 100.

In this case, for example, the controller 90 of the printing inspection apparatus 200 only needs to output the statistical data obtained for each slide direction of the squeegee 13 and the candidates of the cause of the printing failure to the screen printing apparatus 100 via the communication unit 94. Upon reception of the statistical data obtained for each slide direction of the squeegee 13 and the candidates of the cause of the printing failure, the controller 60 of the screen printing apparatus 100 displays those pieces of data on the monitor of the display 62.

In FIGS. 9 and 10, the case where the data of the volume of the soldered part 2 in the inspection data of the soldered part 2 is obtained for each slide direction of the squeegee 13 has been described. Further, in FIGS. 11 and 12, the case where the data of the position of the soldered part 2 in the inspection data of the soldered part 2 is obtained for each slide direction of the squeegee 13 has been described. On the other hand, out of the inspection data of the soldered part 2, the height or area of the soldered part 2 may be obtained for each slide direction of the squeegee 13.

In the description above, the case where the number of squeegees 13 is two has been described, but the number of squeegees 13 may be three or more. The number of squeegees 13 is not particularly limited. In the description above, the case where the slide direction of the squeegee 13 is rightward and leftward has been described. However, the slide direction of the squeegee 13 may be forward, backward, and the like.

The present disclosure may take the following configurations.

(1) A printing inspection apparatus, including:

a measurement unit configured to measure solder that is printed on a substrate with a squeegee of a screen printing apparatus, the screen printing apparatus including a plurality of squeegees that slide on a screen in different slide directions to print solder on different substrates; and

a controller configured to
determine a slide direction of the squeegee that prints the solder based on measured data of the solder, the measured data being obtained by the measurement unit, and
execute statistical processing of inspection data of the solder based on the measured data of the solder for each of the slide directions of the squeegees.
   (2) The printing inspection apparatus according to (1), in which

the controller is configured to
calculate the center of gravity of a volume and the center of gravity of an area of the solder based on the measured data of the solder, and
determine the slide direction of the squeegee that prints the solder based on a position of the center of gravity of a volume and a position of the center of gravity of an area of the solder.
   (3) The printing inspection apparatus according to (1), in which

the controller is configured to
calculate an inclination of height of the solder based on the measured data of the solder, and
determine the slide direction of the squeegee that prints the solder based on the inclination of the height of the solder.
   (4) The printing inspection apparatus according to any one of (1) to (3), in which

the squeegee is configured to print the solder on the substrate to obtain a plurality of soldered parts,

the measurement unit is configured to measure at least two of the soldered parts printed on the substrate, and

the controller is configured to determine the slide direction of the squeegee based on measured data of the at least two of the soldered parts, the measured data being obtained by the measurement unit.

(5) The printing inspection apparatus according to any one of (1) to (4), further including a display configured to display the inspection data obtained for each of the slide directions of the squeegees.
(6) The printing inspection apparatus according to any one of (1) to (5), further including a communication unit configured to communicate with the screen printing apparatus, in which

the controller is configured to output information indicating the inspection data obtained for each of the slide directions of the squeegees to the screen printing apparatus via the communication unit.

(7) The printing inspection apparatus according to any one of (1) to (6), in which

the controller is configured to
detect a printing failure of the solder due to the screen printing apparatus based on the inspection data, and
identify, when the printing failure of the solder is detected, at least one candidate that is assumed to be a cause of the printing failure, based on the inspection data obtained for each of the slide directions of the squeegees.
   (8) The printing inspection apparatus according to (7), further including a display configured to display the at least one candidate that is assumed to be a cause of the printing failure, the at least one candidate being identified by the controller, on a monitor.
   (9) The printing inspection apparatus according to (7) or (8), further including a communication unit configured to communicate with the screen printing apparatus, in which

the controller is configured to output information indicating the identified at least one candidate that is assumed to be a cause of the printing failure to the screen printing apparatus via the communication unit.

(10) The printing inspection apparatus according to (9), in which

the controller is configured to output information indicating the at least one candidate that is assumed to be a cause of the printing failure via the communication unit, to automatically eliminate the cause of the printing failure by the screen printing apparatus.

(11) A printing inspection system, including:

a screen printing apparatus including a plurality of squeegees that slide on a screen in different slide directions to print solder on different substrates; and

a printing inspection apparatus including
a measurement unit configured to measure the solder that is printed on the substrates with the plurality of squeegees of the screen printing apparatus, and
a controller configured to
   determine a slide direction of one of the squeegees that prints the solder based on measured data of the solder, the measured data being obtained by the measurement unit, and
   execute statistical processing of inspection data of the solder based on the measured data of the solder for each of the slide directions of the squeegees.
      (12) A statistical method for inspection data, including:

measuring solder that is printed on a substrate with a squeegee of a screen printing apparatus, the screen printing apparatus including a plurality of squeegees that slide on a screen in different slide directions to print solder on different substrates;

determining a slide direction of the squeegee that prints the solder based on measured data of the solder, the measured data being obtained by the measuring; and

executing statistical processing of inspection data of the solder based on the measured data of the solder for each of the slide directions of the squeegees.

(13) A program causing a printing inspection apparatus to execute:

measuring solder that is printed on a substrate with a squeegee of a screen printing apparatus, the screen printing apparatus including a plurality of squeegees that slide on a screen in different slide directions to print solder on different substrates;

determining a slide direction of the squeegee that prints the solder based on measured data of the solder, the measured data being obtained by the measuring; and

executing statistical processing of inspection data of the solder based on the measured data of the solder for each of the slide directions of the squeegees.

(14) A substrate manufacturing method, including:

measuring solder that is printed on a substrate with a squeegee of a screen printing apparatus, the screen printing apparatus including a plurality of squeegees that slide on a screen in different slide directions to print solder on different substrates;

determining a slide direction of the squeegee that prints the solder based on measured data of the solder, the measured data being obtained by the measuring;

executing statistical processing of inspection data of the solder based on the measured data of the solder for each of the slide directions of the squeegees;

identifying a cause of a printing failure of the solder due to the screen printing apparatus based on the inspection data obtained for each of the slide directions of the squeegees;

eliminating the identified cause of the printing failure due to the screen printing apparatus;

printing the solder on the substrate by the screen printing apparatus from which the cause of the printing failure is eliminated; and

mounting an electronic component onto the substrate on which the solder is printed.

The present disclosure contains subject matter related to that disclosed in Japanese Priority Patent Application JP 2012-021482 filed in the Japan Patent Office on Feb. 3, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A printing inspection apparatus, comprising:
a measurement unit configured to measure solder that is printed on a substrate with a squeegee of a screen printing apparatus, the screen printing apparatus including a plurality of squeegees that slide on a screen in different slide directions to print solder on different substrates; and
a controller configured to
determine a slide direction of the squeegee that prints the solder based on measured data of the solder, the measured data being obtained by the measurement unit, and
execute statistical processing of inspection data of the solder based on the measured data of the solder for each of the slide directions of the squeegees.

2. The printing inspection apparatus according to claim 2, wherein
the controller is configured to
calculate the center of gravity of a volume and the center of gravity of an area of the solder based on the measured data of the solder, and
determine the slide direction of the squeegee that prints the solder based on a position of the center of gravity of a volume and a position of the center of gravity of an area of the solder.

3. The printing inspection apparatus according to claim 1, wherein
the controller is configured to
calculate an inclination of height of the solder based on the measured data of the solder, and
determine the slide direction of the squeegee that prints the solder based on the inclination of the height of the solder.

4. The printing inspection apparatus according to claim 1, wherein
the squeegee is configured to print the solder on the substrate to obtain a plurality of soldered parts,
the measurement unit is configured to measure at least two of the soldered parts printed on the substrate, and
the controller is configured to determine the slide direction of the squeegee based on measured data of the at least two of the soldered parts, the measured data being obtained by the measurement unit.

5. The printing inspection apparatus according to claim 1, further comprising a display configured to display the inspection data obtained for each of the slide directions of the squeegees.

6. The printing inspection apparatus according to claim 1, further comprising a communication unit configured to communicate with the screen printing apparatus, wherein
the controller is configured to output information indicating the inspection data obtained for each of the slide directions of the squeegees to the screen printing apparatus via the communication unit.

7. The printing inspection apparatus according to claim 1, wherein
the controller is configured to
detect a printing failure of the solder due to the screen printing apparatus based on the inspection data, and
identify, when the printing failure of the solder is detected, at least one candidate that is assumed to be a cause of the printing failure, based on the inspection data obtained for each of the slide directions of the squeegees.

8. The printing inspection apparatus according to claim 7, further comprising a display configured to display the at least one candidate that is assumed to be a cause of the printing failure, the at least one candidate being identified by the controller, on a monitor.

9. The printing inspection apparatus according to claim 7, further comprising a communication unit configured to communicate with the screen printing apparatus, wherein
the controller is configured to output information indicating the identified at least one candidate that is assumed to be a cause of the printing failure to the screen printing apparatus via the communication unit.

10. The printing inspection apparatus according to claim 9, wherein
the controller is configured to output information indicating the at least one candidate that is assumed to be a cause of the printing failure via the communication unit, to automatically eliminate the cause of the printing failure by the screen printing apparatus.

11. A printing inspection system, comprising:
a screen printing apparatus including a plurality of squeegees that slide on a screen in different slide directions to print solder on different substrates; and
a printing inspection apparatus including
a measurement unit configured to measure the solder that is printed on the substrates with the plurality of squeegees of the screen printing apparatus, and
a controller configured to
determine a slide direction of one of the squeegees that prints the solder based on measured data of the solder, the measured data being obtained by the measurement unit, and
execute statistical processing of inspection data of the solder based on the measured data of the solder for each of the slide directions of the squeegees.

12. A statistical method for inspection data, comprising:
measuring solder that is printed on a substrate with a squeegee of a screen printing apparatus, the screen printing apparatus including a plurality of squeegees that slide on a screen in different slide directions to print solder on different substrates;
determining a slide direction of the squeegee that prints the solder based on measured data of the solder, the measured data being obtained by the measuring; and
executing statistical processing of inspection data of the solder based on the measured data of the solder for each of the slide directions of the squeegees.

13. A program causing a printing inspection apparatus to execute:
measuring solder that is printed on a substrate with a squeegee of a screen printing apparatus, the screen printing apparatus including a plurality of squeegees that slide on a screen in different slide directions to print solder on different substrates;
determining a slide direction of the squeegee that prints the solder based on measured data of the solder, the measured data being obtained by the measuring; and
executing statistical processing of inspection data of the solder based on the measured data of the solder for each of the slide directions of the squeegees.

14. A substrate manufacturing method, comprising:
measuring solder that is printed on a substrate with a squeegee of a screen printing apparatus, the screen printing apparatus including a plurality of squeegees that slide on a screen in different slide directions to print solder on different substrates;
determining a slide direction of the squeegee that prints the solder based on measured data of the solder, the measured data being obtained by the measuring;
executing statistical processing of inspection data of the solder based on the measured data of the solder for each of the slide directions of the squeegees;
identifying a cause of a printing failure of the solder due to the screen printing apparatus based on the inspection data obtained for each of the slide directions of the squeegees;
eliminating the identified cause of the printing failure due to the screen printing apparatus;
printing the solder on the substrate by the screen printing apparatus from which the cause of the printing failure is eliminated; and
mounting an electronic component onto the substrate on which the solder is printed.
